(19) United States
(12) Patent Application Publication
(10) Pub. No.: US 2015/0039360 A1
(43) Pub. Date: Feb. 5, 2015

(54) DEPENDENCY MANAGEMENT FOR ENTERPRISE COMPUTING

(71) Applicant: Yahoo! Inc., Sunnyvale, CA (US)

(72) Inventors: Vijay Muthugadooru Gowdra, Bangalore (IN); Ravishankar Suribabu Koratagare, Bangalore (IN)

(73) Assignee: Yahoo! Inc., Sunnyvale, CA (US)

(21) Appl. No.: 13/956,178

(22) Filed: Jul. 31, 2013

(51) Int. Cl. G06Q 10/06

(52) U.S. Cl. CPC G06Q 10/0631
USPC 705/7.12

(57) ABSTRACT

Briefly, embodiments disclosed herein may relate to managing dependencies among software components executed in enterprise computing environments, for example.

### BACKGROUND

1. Field

Subject matter disclosed herein may relate to managing dependencies among software components executed in enterprise computing environments, for example.

2. Information

Large enterprises, such as governments and/or large corporations, for example, may utilize computing systems that stretch across an enterprise. For example, a large corporation may include a large number of divisions or other business units. Individual divisions and/or other business units may operate computer systems to execute software developed with specific tasks in mind for the respective business units. Often, computer systems in different business units within a large corporation may communicate with each other, and/or may share software applications, and/or digital objects, for example.

In large enterprises such as those mentioned above, changes to an application executed on a computer system in one part of the enterprise may have an impact on computer systems and/or software applications in another part of the enterprise. Managing such changes is a complex task.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram illustrating an example enterprise, according to an embodiment.

FIG. 2 is a schematic diagram illustrating an example dependency management system, in accordance with an embodiment.

FIG. 3 is a schematic block diagram illustrating an example dependency management system, in accordance with an embodiment.

FIG. 4 is a flow diagram illustrating an example process for managing dependencies across and/or within computing systems, according to an embodiment.

FIG. 5 is a schematic diagram illustrating an example information flow between various components of a dependency management system, in accordance with an embodiment.

FIG. 6 is a schematic diagram illustrating an example software stack for an example dependency management system, in accordance with an embodiment.

FIG. 7 is a schematic diagram illustrating an example canonical data model for an example dependency management system, according to an embodiment.

FIG. 8 is a schematic diagram illustrating an example metadata table organization in accordance with an embodiment.

FIG. 9 is a schematic diagram illustrating an example computing device in accordance with an embodiment.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

Reference throughout this specification to one implementation, an implementation, one embodiment, an embodiment and/or the like may mean that a particular feature, structure, or characteristic described in connection with a particular implementation or embodiment may be included in at least one implementation or embodiment of claimed subject matter. Thus, appearances of such phrases, for example, in various places throughout this specification are not necessarily intended to refer to the same implementation or to any one particular implementation described. Furthermore, it is to be understood that particular features, structures, or characteristics described may be combined in various ways in one or more implementations. In general, of course, these and other issues may vary with context. Therefore, particular context of description or usage may provide helpful guidance regarding inferences to be drawn.

Operations and/or processing, such as in association with networks, such as communication networks, for example, may involve physical manipulations of physical quantities. Typically, although not necessarily, these quantities may take the form of electrical and/or magnetic signals capable of, for example, being stored, transferred, combined, processed, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these or similar terms are to be associated with appropriate physical quantities and are intended to merely be convenient labels.

Likewise, in this context, the terms “coupled”, “connected,” and/or similar terms, may be used. It should be understood that these terms are not intended as synonyms. Rather, “connected” may be used to indicate that two or more elements or other components, for example, are in direct physical and/or electrical contact; while, “coupled” may mean that two or more components are in direct physical or electrical contact; however, “coupled” may also mean that two or more components are not in direct contact, but may nonetheless co-operate or interact. The term coupled may also be understood to mean indirectly connected, for example, in an appropriate context.

The terms, “and”, “or”, “and/or” and/or similar terms, as used herein, may include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms may be used to describe any feature, structure, and/or characteristic in the singular and/or may be used to describe a plurality or some other combination of features, structures and/or characteristics. Though, it should be noted that this is merely an illustrative example and claimed subject matter is not limited to this example. Again, particular context of description or usage may provide helpful guidance regarding inferences to be drawn.

It should be understood that for ease of description a network device may be embodied and/or described in terms of a computing device. However, it should further be understood that this description should in no way be construed that claimed subject matter is limited to one embodiment, such as a computing device or a network device, and, instead, may be embodied as a variety of devices or combinations thereof, including, for example, one or more illustrative examples.

In this context, the term network device refers to any device capable of communicating via and/or as part of a network. Network devices may be capable of sending and/or receiving signals (e.g., signal packets), such as via a wired or wireless network, may be capable of performing arithmetic and/or logic operations, processing and/or storing signals, such as in memory as physical memory states, and/or may, for example, operate as a server. Network devices capable of operating as a server, or otherwise, may include, as examples, dedicated rack-mounted servers, desktop computers, laptop computers, set top boxes, tablets, netbooks, smart phones, integrated devices combining two or more features of the foregoing devices, the like or any combination thereof.

A network may comprise two or more network devices and/or may couple network devices so that signal communications, such as in the form of signal packets, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices or one or more server devices, as appropriate. Along similar lines, references to a “database” are understood to mean one or more databases and/or portions thereof, as appropriate.

A network may also include now known, or to be later developed arrangements, derivatives, and/or improvements, including, for example, past, present and/or future mass storage, such as network attached storage (NAS), a storage area network (SAN), and/or other forms of computer and/or machine readable media, for example. A network may include the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures or may be compliant and/or compatible with differing protocols, such as communication protocols (e.g., network communication protocols), may interoperate within a larger network. Various types of devices may be made available so that device interoperability is enabled and/or, in at least some instances, may be transparent to the devices. In this context, the term transparent refers to devices communicating via a network in which the devices are able to communicate via intermediate devices, but without the communicating devices necessarily specifying one or more intermediate devices and/or may include communicating as if intermediate devices are not necessarily involved in communication transmissions. For example, a router may provide a link between otherwise separate and/or independent LANs. In this context, a private network refers to a particular, limited set of network devices able to communicate with other network devices in the particular, limited set, such as via signal packet transmissions, for example, without a need for re-routing and/or redirecting such communications. A private network may comprise a stand-alone network; however, a private network may also comprise a subset of a larger network, such as, for example, without limitation, the Internet. Thus, for example, a private network “in the cloud” may refer to a private network that comprises a subset of the Internet, for example. Although signal packet transmissions may employ intermediate devices to exchange signal packet transmissions, those intermediate devices may not necessarily be included in the private network by not being a source or destination for one or more signal packet transmissions, for example. As another example, a logical broadcast domain may comprise an example of a private network. It is understood in this context that a private network may provide outgoing communications to devices not in the private network, but such devices outside the private network may not direct inbound communications to devices included in the private network.

The Internet refers to a decentralized global network of interoperable networks, including devices that are part of those interoperable networks. The Internet includes local area networks (LANs), wide area networks (WANs), wireless networks, and/or long haul public networks that, for example, may allow signal packets to be communicated between LANs. The term world wide web (WWW) and/or similar terms may also be used to refer to the Internet. Signal packets, also referred to as signal packet transmissions, may be communicated between nodes of a network, where a node may comprise one or more network devices, for example. As an illustrative example, but without limitation, a node may comprise one or more sites employing a local network address. Likewise a device, such as a network device, may be associated with that node. A signal packet may, for example, be communicated via a communication channel or a communication path comprising the Internet, from a site via an access node coupled to the Internet. Likewise, a signal packet may be forwarded via network nodes to a target site coupled to a local network, for example. A signal packet communicated via the Internet, for example, may be routed via a path comprising one or more gateways, servers, etc. that may, for example, route a signal packet in accordance with a target address and availability of a network path of network nodes to a target address.

Physically connecting a network via a hardware bridge as one example may be done, although other approaches also exist. A hardware bridge, however, may not typically include a capability of interoperability via higher levels of a network protocol. A network protocol refers to a set of signaling conventions for communications between or among devices in a network, typically network devices; for example, devices that substantially comply with the protocol or that are substantially compatible with the protocol. In this context, the term “between” and/or similar terms are understood to include “among” if appropriate for the particular usage. Likewise, in this context, the terms “compatible with”, “comply with” and/or similar terms are understood to include substantial compliance or substantial compatibility.

Typically, a network protocol has several layers. These layers may be referred to here as a communication stack. Various types of communications may occur across various layers. For example, as one moves higher in a communication stack, additional functions may be available by transmitting communications that are compatible and/or compliant with a particular network protocol at these higher layers. In contrast, a virtual private network (VPN) may enable a remote device to communicate via a local network. A router may allow communications in the form of transmissions (e.g., signal packets), for example, to occur from a remote device to a VPN server on a local network. A remote device may be authenticated and a VPN server, for example, may create a special route between a local network and the remote device through an intervening router.

Although claimed subject matter is not in particular limited in scope to the Internet or to the web, it may without limitation provide a useful example of an embodiment for purposes of illustration. As indicated, the Internet may comprise a worldwide system of interoperable networks, including devices within those networks. The internet has evolved to a public, self-sustaining facility that may be accessible to tens of millions of people or more worldwide. Also, in an embodiment, a widely used part of the Internet may comprise the World Wide Web, often abbreviated “WWW” or simply referred to as just “the web”. As mentioned, the terms Internet, web and/or similar terms may, therefore, be used interchangeably. The web, therefore, in this context, may comprise an Internet service that organizes stored content, such as, for example, text, images, video, etc., through the use of hypermedia. For example, a HyperText Markup Language (“HTML”) may be utilized to specify content and/or format of hypermedia type content, such as in the form of a file or an “electronic document,” such as a web page, for example. An Extensible Markup Language (XML) may also be utilized to specify content and/or format of hypermedia type content, such as in the form of a file or an “electronic document,” such as a web page, in an embodiment. Of course, HTML and XML are merely example languages provided as illustrations. Claimed subject matter is not intended to be limited to examples provided as illustrations, of course.

As used herein, a “web site” may refer to a collection of related web pages, in an embodiment. Also as used herein, “web page” may relate to any electronic file or electronic document, such as may be accessible via a network, by specifying a URL for accessibility via the web, in an example embodiment. As alluded to above, in one or more embodiments, a web page may comprise content coded using one or more languages, such as, for example, HTML and/or XML, although claimed subject matter is not limited in scope in this respect. Also, in one or more embodiments, application developers may write code in the form of JavaScript, for example, to provide content to populate one or more templates, such as for an application. However, JavaScript is merely an example programming language. As was mentioned, claimed subject matter is not limited to examples or illustrations.

As used herein, the term “entry”, “electronic entry”, “document”, “electronic document” and/or similar terms are meant to refer to signals and/or states in a digital format that may be perceived by a user if displayed by a digital device, such as, for example, a computing device. For one or more embodiments, an electronic document may comprise a web page coded in a markup language, such as, for example, HTML (hypertext markup language). In another embodiment, an electronic document may comprise a portion or a region of a web page. However, claimed subject matter is not limited in these respects.

As mentioned, large enterprises, such as governments and/or large corporations, for example, may utilize computing systems that stretch across the enterprise. For example, a large corporation may include a large number of divisions and/or other business units. Individual divisions and/or other business units may operate computer systems to execute software developed with specific tasks for the respective business units and/or divisions. Often, computer systems in different business units within a large corporation may communicate with each other, and/or may share computer-executed applications and/or digital objects comprising business-related data, for example. In large enterprises such as those mentioned, changes to an application executed on a computer system in one part of an enterprise may, therefore, intentionally and/or unintentionally have an impact on computer systems and/or computer-executed applications in one or more other parts of the enterprise. Managing changes to an application executed by a computer system may, therefore, comprise a complex task.

As used herein, the term “component” in some contexts is meant to refer to a portion of an enterprise computing system. In some embodiments, a component may comprise a computer system, or a portion thereof, associated with an organization within a larger enterprise. For example, a large corporation may utilize computer systems comprising one or more components in various individual business units. Computer systems may, for example, be networked together, and may interact, for example. Within an organization and/or within an individual computer system, one or more components of a computer system may interact with another. Further, in an embodiment, a component may comprise hardware, software, and/or firmware, or a combination thereof, other than software per se.

Further, as used herein, the term “digital object” may refer to a data structure comprising digital material. For example, a digital object may comprise an application executable by a computer system, and/or may comprise data and/or metadata related to one or more components of an enterprise, in an embodiment. Further, for example, a digital object may comprise an electronic entry and/or an electronic document, in an embodiment. However, these are merely example digital objects, and claimed subject matter is not limited in scope in these respects.

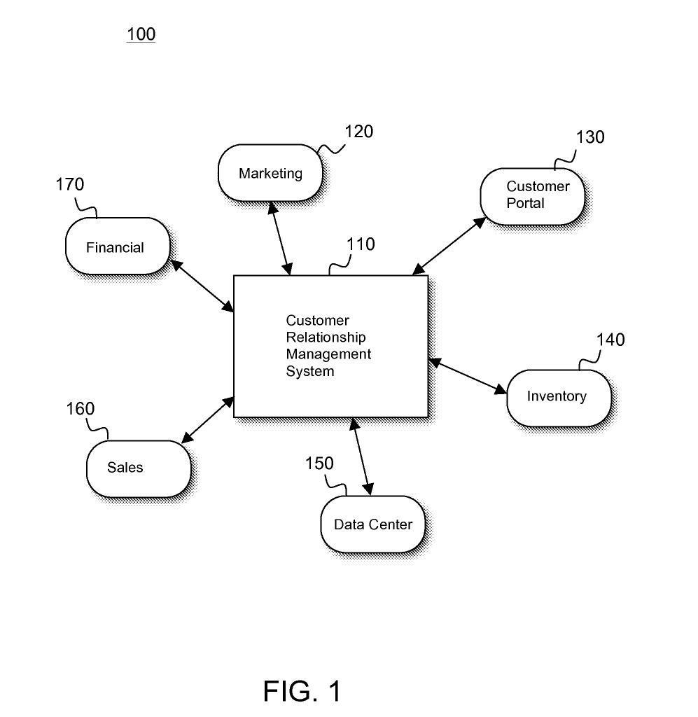

FIG. 1 is a schematic diagram illustrating an example enterprise 100, according to an embodiment. In an embodiment, enterprise 100 may comprise a customer relationship manager 110 that communicates with a number of organizations and/or systems within enterprise 100. In an embodiment, a customer relationship manager, such as customer relationship manager 110, for example, may comprise an application executed on a computer system. A customer relationship manager, such as customer relationship manager 110, for example, may comprise an application to track various information related to an enterprise's customers. For example, a customer relationship manager may, for example, track information related to marketing campaigns and/or customer prospecting activities, and/or may manage customer orders, to name but a few examples, although claimed subject matter is not limited in scope in these respects.

In an embodiment, example enterprise 100 may include a marketing organization 120, a financial organization 170, an inventory system 140, a data center 150, a customer portal 130, and/or a sales organization 160. Also, in an embodiment, individual organizations within enterprise 100 may incorporate any number of computer systems executing any number of applications. Of course, enterprise 100 is merely an example enterprise, and claimed subject matter is not limited in scope in these respects.

For a large system, such as for enterprise 100, for example, managing change within a computer system and/or a computer-executed application may comprise a complex task. For example, making changes to an application executed on a computer system in one part of an enterprise may impact operation of computer systems, including applications executed by computer systems, in various other parts of the enterprise. More specifically, changes made to an application in one system may produce errors and/or malfunctions in any number of other applications in that one system and/or in any number of applications across other systems within an enterprise, for example.

Changes to an application may be readily checked for syntactic correctness, for example, within a particular system before a change to the application is deployed. Semantic flaws may also be corrected within boundaries of a particular system. However, errors attributable to a change in one system that may affect other systems across an enterprise may not be easily detected, nor may errors be easily reported and/or corrected. Further, errors attributable to changes in one system that may affect other systems across an enterprise may prove costly. For example, errors may render systems across an enterprise inoperable and/or unreliable, which condition may negatively impact operations in systems across an enterprise, for example.

For example, a change made to an inventory tracking application executed on a computer system within an individual organization, such as inventory system 140, of an enterprise, such as enterprise 100, may impact not only an individual organization, such as inventory system 140, but may also negatively impact any number of other organizations of enterprise 100. For example, a change made to an application within inventory system 140 may negatively impact applications executed within sales organization 160, financial organization 170, marketing organization 120, and/or customer relationship management system 110, for example.

As an example, consider a customer relationship management system 110, which may interact with a number of computer systems in various organizations within enterprise 100, such as marketing organization 120, financial organization 170, inventory system 140, data center 150, customer portal 130, and/or sales organization 160. For this example, it may be desirable for any change to an application in customer relationship management system 110 to be validated for inconsistencies within customer relationship management system 110 and also for inconsistencies that may potentially negative affect other systems in other organizations. Potential negative impact of a change in an application within customer relationship management system 110 may include delayed deliveries, lower quality of deliverables, longer turnaround times, and/or more frequent defects in goods and/or services provided by various impacted organizations across enterprise 100, for example. Of course, these are merely example types of organizations within an enterprise that may be negatively impacted by changes to applications in other organizations within an enterprise, and claimed subject matter is not limited in scope in these respects. In an embodiment, further complexities may be introduced in response to multiple systems within an enterprise changing concurrently. Detecting and/or identifying potential negative impacts to various dynamic systems within an enterprise may comprise an important objective of example embodiments of dependency management systems.

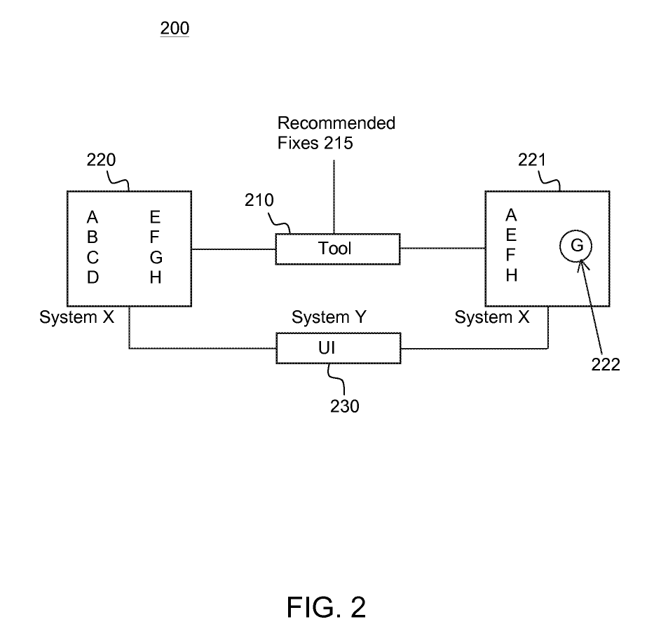

FIG. 2 is a schematic diagram illustrating an embodiment 200 of a dependency management system, in accordance with an embodiment. Dependency management system 200, in an embodiment, may detect and/or identify dependencies that may exist among various computer systems across an enterprise. Also, in an embodiment, dependency management system 200 detect and/or identify inconsistencies among detected dependencies and may recommend fixes for detected inconsistencies. In another embodiment, dependency management system 200 may automatically apply fixes to detected inconsistencies.

As used herein, a fix may comprise adjustments and/or modifications to one or more data, applications, and/or computer systems to correct and/or improve identified and/or detected inconsistencies among identified and/or detected dependencies. In an embodiment, a fix may reduce potential negative impact that may result from one or more changes to one or more applications in an enterprise. Also, in an embodiment, a fix may be implemented by a user in response to a communication of recommended fixes via a display of a computing system. In an alternative embodiment, a fix may be implemented without user intervention by a computer system in response to generation of one or more recommended fixes, for example. Of course, these are merely example aspects of a fix and/or fix implementation, and claimed subject matter is not limited in scope in these respects.

For the example of FIG. 2, a metadata repository 220 of an example system X may store example digital objects A through H. As an example, consider that development activity for an application within a computer system results in objects B, C, D, and G becoming inactive. However, for this example, consider that another example system Y comprises a user interface 230 that may rely on availability and/or accessibility of object G. Thus, a change in an application to objects B, C, D, and G may results in a negative impact to user interface 230, in an example. In an embodiment, a dependency management tool 210 may detect dependencies for objects A through H. Specifically, for example, dependency management tool 210 may detect that user interface 230 utilizes object G, and dependency management tool 210 may detect that a change in status for object G may negatively impact user interface 230.

For the example of FIG. 2, a user interacting with user interface 230 may detect an absence of object G unless a fix is performed to repository 220 to ensure that object G is not made inactive. In an embodiment, dependency management tool 210 may detect a dependency between user interface 230 and object G of repository 220, and may report recommended fixes 215 to a user in response to a change to object G of repository 220. A user may receive a report comprising recommended fixes 215 from dependency management tool 210, and a user may implement one or more fixes, such as restoring object G to repository 220, for example. Repository 221 of FIG. 2 represents repository 220 with fixes having been implemented, which in the present example include a restoration of object G. In another embodiment, dependency management tool 210 may implement one or more fixes, at least in part, although claimed subject matter is not limited in scope in this respect. In this manner, a change may be made to repository 220 by one system in an enterprise, and dependency management tool 210 may generate and/or may implement recommended fixes 215 to reduce negative implications for user interface 230 as a result of changes made to repository 220, for example.

In an embodiment, an example dependency management system may comprise a software component comprising a set of attributes. Attributes may be either of simple or complex, in an embodiment. For example, an attribute of a software component of a dependency management system may comprise metadata for the software component. Also, in an embodiment, simple attributes for a dependency management system may comprise attributes that are not dependent on any other attribute. Additionally, complex attributes for a dependency management system, in an embodiment, may comprise logical associations of more than one simple attribute.

Further, in an embodiment, dependencies between components of various systems of an enterprise may comprise references and/or associations between components with reference to the attributes they comprise. For example, in an embodiment, a dependency between a simple attribute of a first component of a system and an attribute of a second component of the same or different system of an enterprise may be established by a simple attribute of the first component pointing to an attribute of the second component. Also, in an embodiment, a complex attribute may refer to other attributes of a same component and/or of other components of an enterprise.

In an embodiment, dependencies, denoted symbolically as ‘←’ may be mathematically categorized as follows: Simple Dependency—If Cp and C′q comprise attributes of components C and C′, and if Cp is dependent on C′q, then Cp←C′q, which also implies C←C′; Transitive Dependency—If C, C and C″ comprise three components, and if C←C′ and C′←C″, then C←C″; Reflexive Dependency—If C and C′ comprise two components, and if C is dependent on C′ and vice versa, then C←C′ and C′←C; and Self Dependency—a simple dependency between attributes of a same component. Of course, this is merely an example of how dependencies may be categorized, and claimed subject matter is not limited in these respects. In one or more embodiments, dependency rules may include data type matches, integration mappings, identification (ID) references, value references, and so forth. In an embodiment, the term “dependency rule” may refer to one or more conditions against which one or more detected and/or identified dependencies among one or more digital object attributes in an enterprise may be compared to determine potential negative impact that may result from a change to an application executable by a computer system of the enterprise, for example.

In an embodiment, a goal of a dependency management system may include validation of digital object attributes of a component of a system in an enterprise to references within the same component or within other components across an enterprise. For example, in an embodiment, a dependency list may be generated at least in part by detecting and/or identifying dependencies among one or more digital object attributes for one or more computer systems in one or more organizations and/or divisions in an enterprise. Also, in an embodiment, a dependency list may be analyzed in light of specified dependency rules to detect dependency issues and/or to resolve dependency issues.

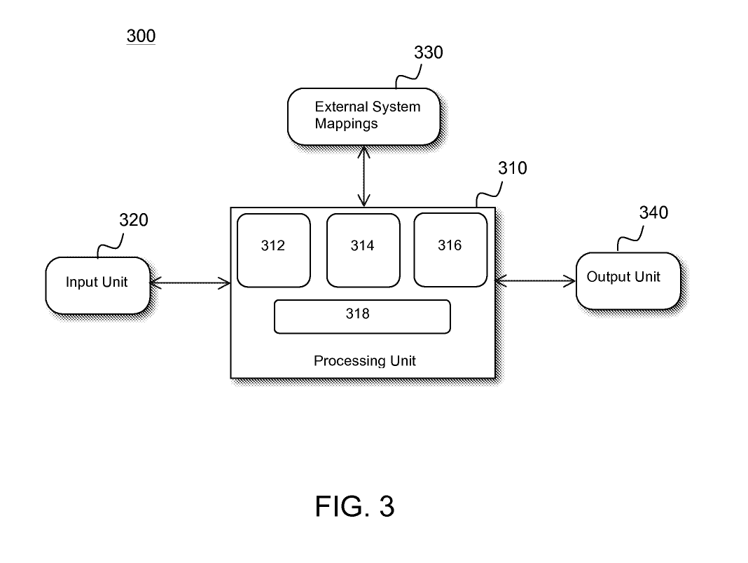

FIG. 3 is a schematic block diagram illustrating an embodiment 300 of an example dependency management system. In an embodiment, a dependency management system, such as dependency management system 300, may comprise an input unit 320, a processing unit 310, and an output unit 340. In an embodiment, a dependency management system input unit, such as input unit 320, may maintain a configuration and/or state of a dependency management system, such as dependency management system 300. In an embodiment, a configuration and/or state of a dependency management system may be stored as a comma separated value (CSV) list, or as another type of digital object. Of course, claimed subject matter is not limited in scope in this respect.

In an embodiment, a dependency management system, such as dependency management system 300, may comprise a master configuration file, such as master configuration file 312, a template file, such as template file 314, and/or a rules file, such as rules file 316, for example. In an embodiment, a master configuration file may comprise a digital object in which access credentials to computing systems and/or components that may interact with dependency management system 300 may be stored, although claimed subject matter is not limited in scope in these respects. Mappings to external systems may be provided, for example, by external system mappings 330. Also, in an embodiment, a template file, such as template file 314, may store digital object attributes of various components of various computing systems that may be compared in dependency determination operations. In an embodiment, digital object attributes may comprise metadata for various components, for example. Additionally, in an embodiment, a rules file, such as rules file 316, may store dependency rules to be used in evaluating dependencies among various components of an enterprise.

Also, in an embodiment, a processing unit, such as processing unit 310 of a dependency management system, such as dependency management system 300, may request and/or receive input from an input unit, such as input unit 320. In an embodiment, input from input unit 320 may comprise an indication of an action to be initiated by processing unit 310. In an embodiment, at least in part in response to receiving input from input unit 320, processing unit 310 may perform validation operations specified at least in part by contents of rules file 316, for example. Validation operations may further be specified, at least in part, by metadata stored in in template file 314, and/or by access credentials stored in master configuration file 312. In an embodiment, validation operations may be performed, at least in part, by a rules checker engine, such as rules checker engine 318, for example. In an embodiment, processing unit 310 may take advantage of digital object attributes and/or dependency information gleaned from previous operations performed by dependency management system 300 to reduce and/or eliminate redundant dependency checks.

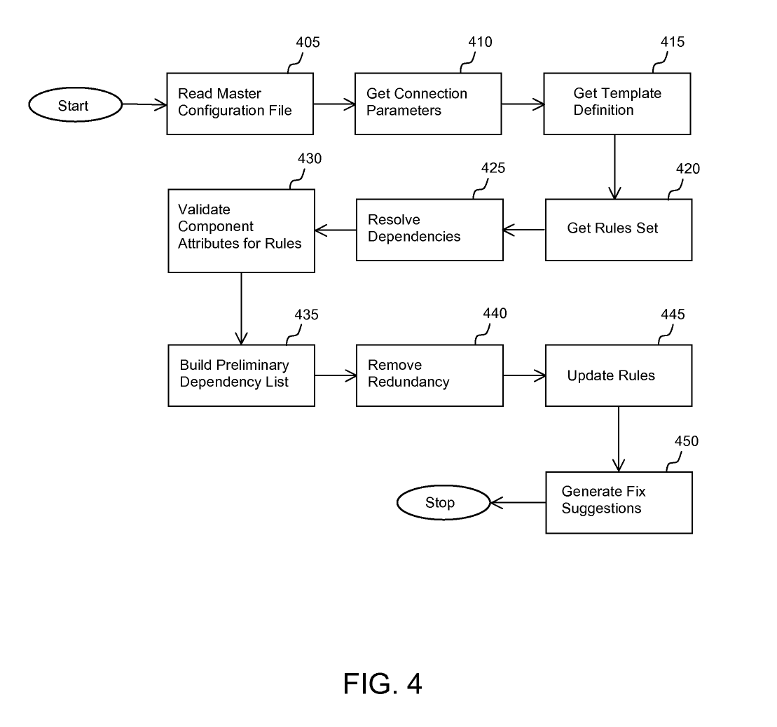

FIG. 4 is a flow diagram illustrating an example process for managing dependencies across and/or within computing systems, according to an embodiment. In an embodiment, dependency management operations may be performed by a dependency management system, such as dependency management system 300, for example. In an embodiment, an example process illustrated in FIG. 4 may be performed at least in part by a dependency management system processing unit, such as processing unit 310 depicted in FIG. 3, for example.

In an embodiment, a master configuration file, such as master configuration file 312 depicted in FIG. 3, may be read, as depicted at block 405, for example. At block 410, connection parameters for various components may be gathered. In an embodiment, an input unit, such as input unit 320, may provide a list of components to be validated. As depicted at block 410, connection parameters may be gathered. In an embodiment, access credentials for specified components may be gathered from a file, such as master configuration file 312, for example.

As depicted at block 415, a template definition may be obtained. In an embodiment, a template definition may be obtained from a template file, such as template file 314, for example. Also, in an embodiment, a template file, such as template file 314, may comprise metadata for digital object attributes associated with various components. In an embodiment, template information, such as metadata, for components to be evaluated for dependency issues may be retrieved at block 415. Additionally, as depicted at block 420, a rules set may be obtained. In an embodiment, a rules set may be obtained from a rules file, such as rules file 316, for example. In an embodiment, a rules file, such as rules file 316, may store dependency rules to be used in evaluating dependencies among various components, for example. In an embodiment, template definitions and rules may be obtained as depicted at block 415 and 420 for components to be evaluated as part of dependency management operations.

Also, in an embodiment, for individual rules of a rules set obtained at block 420, dependencies for specified components may be determined, as specified at block 425. In an embodiment, access parameters for individual components may be obtained from a configuration file, such as master configuration file 312, for example. Additionally, component attributes may be validated against a rules set, as depicted at block 430. In an embodiment, blocks 425 and 430 may be performed for individual specified components to be evaluated.

As indicated at block 435, a preliminary dependency list may be generated. In an embodiment, various dependency types may be included, including, for example, simple dependencies, transitive dependencies, reflexive dependencies, and/or self-dependencies, although claimed subject matter is not limited in scope in these respects. Also, in an embodiment, individual dependencies listed in a preliminary dependency list may be checked against a past rule and/or against past results of validation operations in an effort to reduce redundant and/or unnecessary rules and/or dependencies. As indicated at block 440, detected redundancies may be removed, and a rules set may be updated at block 445, and a revised dependency list may be generated.

Further, as depicted at block 450, fix suggestions may be generated, for example. In an embodiment, dependencies may be checked against rules specified in a rules list by a processing unit, such as dependency management system processing unit 310 depicted in FIG. 3. Fix suggestions may be generated based at least in part on results from dependency management system processing unit. In an embodiment, results from dependency management system processing unit with respect to dependency checks may be provided to an output unit, such as output unit 340. In an embodiment, output unit 340 may record results of dependency management system operations. Further, in an embodiment, an output unit, such as output unit 340, may provide fix suggestions to a user by way of a display device, for example. Fix suggestions may take the form of a comma separated value list, or other type of digital object. In some embodiments, fix suggestions may comprise a listing of problematic dependencies detected during rules checking. In other embodiments, fix suggestions may comprise recommendations of actions that may be taken by a user to correct detected dependency issues. In an embodiment, a user may make alterations to an application in order to reduce negative impact of a change of an application for an enterprise, for example.

Embodiments in accordance with claimed subject matter may include all of blocks 405-450, fewer than blocks 405-450, or more than blocks 405-450. Additionally, the order of blocks 405-450 is merely an example order, and claimed subject matter is not limited in scope in this respect.

In an embodiment, dependency management system operations may be performed in anticipation of an upgrade to a software application, for example. In an embodiment, output generated by an output unit, such as output unit 340, may comprise warnings related to inconsistencies that may be detected during dependency management system operations related to the anticipated upgrade. Warnings may alert a user before an application upgrade is applied system-wide, and appropriate actions may be taken to correct issues that may arise before issues have a chance to result in down-time or to result in other negative impact. In an embodiment, appropriate actions may comprise making alterations to an application based on detected inconsistencies, for example, to reduce potential negative impact to an enterprise.

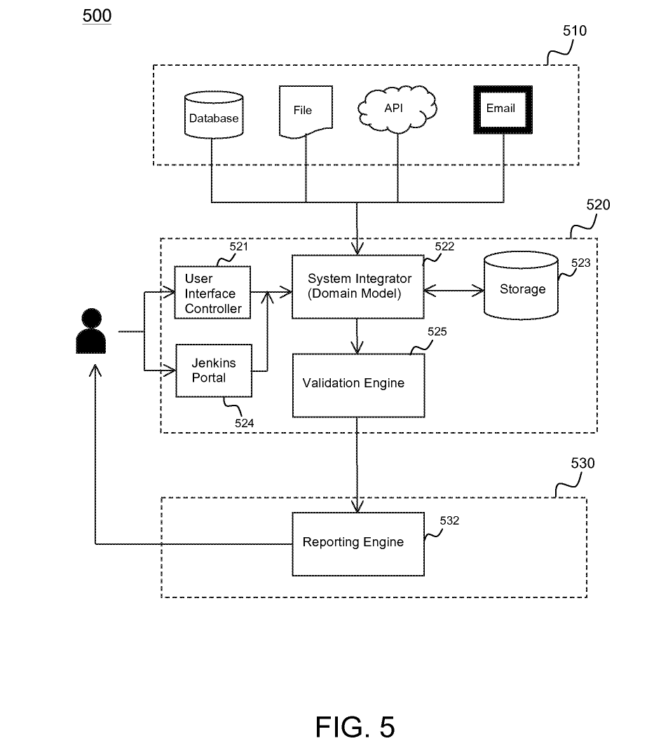

FIG. 5 is a schematic diagram illustrating an example embodiment 500 of an example dependency management system, in accordance with an embodiment. Depicted in FIG. 5 is a metadata store 510 for various systems in an enterprise computing system. Metadata store 510 may comprise, for example, metadata related to one or more databases, files, application programming interfaces (API), and/or email and/or messaging systems, in an embodiment.

FIG. 5 also depicts an example dependency management system framework 520, in accordance with an embodiment. In an embodiment, a framework, such as framework 520, may comprise an organizational structure and/or architecture for a software application to be executed on one or more computer systems in an enterprise, for example. In an embodiment, framework 520 may comprise a user interface controller 521, a Jenkins portal 524, a system integrator 522, a storage unit 523, and a validation engine 525. In an embodiment, validation engine 525 may comprise a dependency check unit, for example, that may detect and/or identify inconsistencies and/or dependency issues for one or more computer systems in an enterprise, for example. Also, in an embodiment, Jenkins portal 524 may comprise an open-source integration tool written in Java programming language. Of course, claimed subject matter is not limited in scope in these respects. In an embodiment, a user may log into dependency management system 500 by utilizing user interface controller 521, for example. A user may select and/or otherwise specify a system within an enterprise to be verified. In an embodiment, dependency management system framework 520 may retrieve metadata from one or more systems of an enterprise. In an embodiment, metadata retrieval may comprise a daily batch process, for example.

In an embodiment, system integrator 522 of framework 520 may store retrieved metadata in a local storage in a canonical domain model. As used herein, the term “canonical model” refers to a specified manner in which various systems of an enterprise may communicate information, such as attribute metadata associated with systems and/or components, to a centralized resource, such as dependency management system framework 520 and system integrator 522. In an embodiment, metadata retrieved from various systems of an enterprise may be stored at system integrator 522 on a domain-by-domain basis. In an embodiment, a domain may comprise a subset of an enterprise. Domains may include, for example, systems and/or components of an enterprise. In an embodiment, storage of retrieved metadata according to a canonical model may be performed as a daily batch process in conjunction with a daily batch process of retrieving metadata. Further, in an embodiment, metadata may be stored in accordance with specific versions. Systems for which dependency management operations may be performed may check version information for other dependent systems, for example. In an embodiment, validation engine 525 may perform dependency validation operations and may report results to a reporting engine, such as reporting engine 532 of reporting tool 530.

In an embodiment, dependency management system framework 520 may advantageously be ported onto a Jenkins infrastructure framework for execution, for example if metadata retrieval and/or storage are performed as a batch process, although claimed subject matter is not limited in scope in this respect.

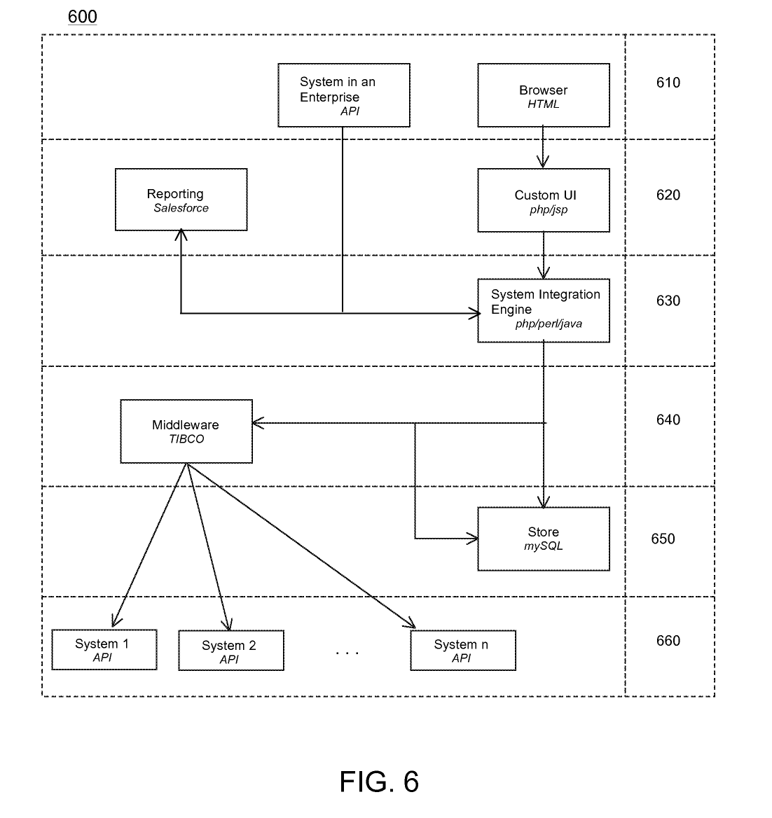

FIG. 6 is a schematic diagram illustrating an embodiment 600 of an example software stack for an example dependency management system. Example software stack 600 of FIG. 6 depicts example software components, logical relationships, and interactions, although claimed subject matter is not limited in scope in these respects. In an embodiment, software stack may comprise different layers with individual roles and responsibilities. FIG. 6 further depicts example communications among various layers. As used herein, the term “layer” in this context may refer to an organizational and/or logical construct related to a software application, wherein different layers of a software stack, such as software stack 600, may include individual roles and responsibilities, for example, and/or may perform specified tasks, in an embodiment.

In an embodiment, a dependency management system may comprise six layers, including user agent layer 610, presentation layer 620, server layer 630, middleware layer 640, store layer 650, and client metadata store layer 660. In an embodiment, user agent layer 610 may represent web browsers and other custom applications that may access services provided by a dependency management system, such as by manual initiation of services by user click or system initiation of services via API. Additionally, presentation layer 620 may render various user interface components on a web browser with metadata gathered from server layer 630. In an embodiment, it may be advantageous to provide a consistent interface across various functional points to provide similar look and feel, consistent integrated experience, and/or a perception of high performance for a user. Additionally, presentation layer 620 may provide a reporting function to enable reports to be delivered to various users and/or systems. Reports may comprise results from dependency management system operations, for example.

Further, in an embodiment, store layer 650 may provide persistent storage of metadata retrieved from various systems in an enterprise, such as retrieved from client metadata store layer 660. Store layer 650 may maintain a state of canonical models from various systems in a central location. Canonical model state storage may be persistent, but may be refreshed periodically with metadata from respective systems, and/or when specified, for example. In an embodiment, different versions of metadata may be stored for audit and/or tracking purposes. Storage of various versions of metadata may help system administrators understand how metadata has changed over multiple releases of an application, for example. In an embodiment, data storage may comprise a single table having a flat structure, although claimed subject matter is not limited in scope in this respect.

In an embodiment, server layer 630 may comprise parsing logic to determine metadata differences between a source system and/or component and a target system and/or component. Further, in an embodiment, middleware layer 640 may apply transformation logic to convert system specific metadata into a specified canonical model to help enable server layer 630 to determine metadata differences. Additionally, server layer 630 may receive and/or process interface requests from various systems in an enterprise. Server layer 630 may further provide responses to requests received from a user, for example. Server layer 630 may utilize protocols such as Web services, flat file transfer, database lookups and so forth, and may also provide lookups into applications such as Sherpa and other databases, in an embodiment.

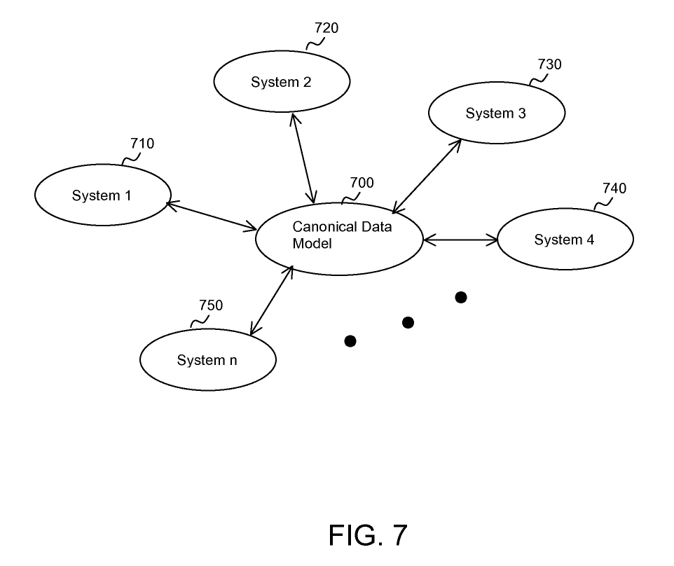

FIG. 7 is a schematic diagram illustrating an embodiment 700 of an example canonical data model for an example dependency management system. In an embodiment, canonical data model 700 may represent persistent objects and their relationships in an example dependency management system. In an embodiment, a canonical model may comprise a super-set of various components and/or entities of various systems 710, 720, 730, 740, and 750 in an enterprise. As mentioned previously, as used herein the term “canonical model” refers to a specified manner in which various systems of an enterprise may communicate information, such as attribute metadata associated with systems and/or components, to a centralized resource.

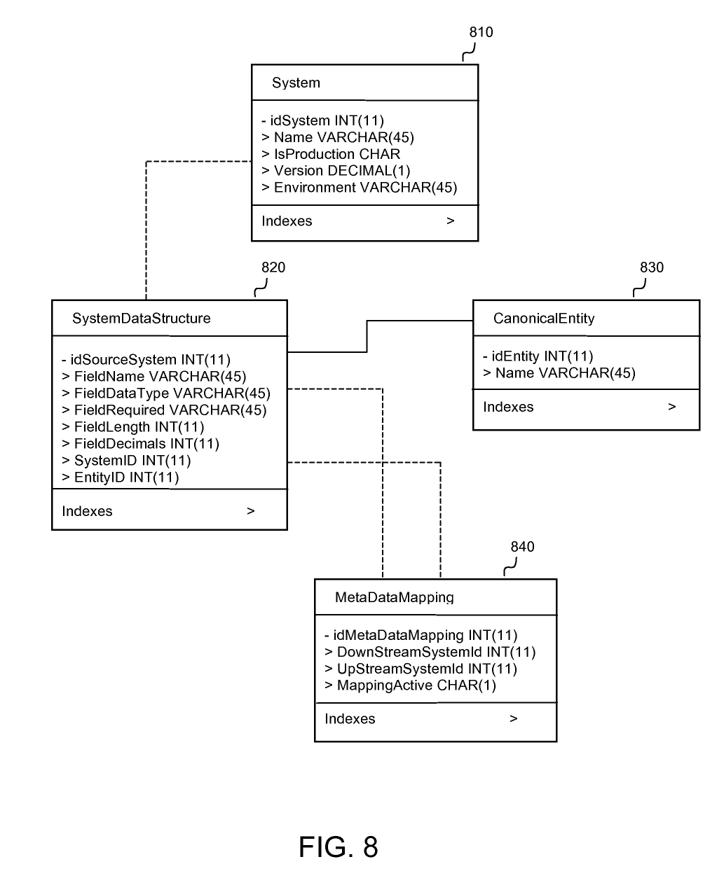

FIG. 8 is a schematic diagram illustrating an example metadata table organization in accordance with an embodiment. In an embodiment, an example dependency management system may specify a canonical data model whereby metadata from systems across an enterprise may be gathered and/or stored in a central location. In an embodiment, a metadata storage system may comprise system tables 810, canonical entity tables 830, system data structure tables 820, and/or metadata mapping tables 840, for example.

In an embodiment, a system table 810 may store metadata related to systems subscribing to and/or otherwise participating in dependency management system operations. Metadata contained in system table 810 may include, for example, system name, system ID, version number, and/or production specifications, although claimed subject matter is not limited in scope in this respect.

Also, in an embodiment, a canonical entity table 830 may store metadata associated with individual canonical entities in an enterprise, for example. In an embodiment, canonical entity table 830 may contain an entity ID and an entity name, for example. Further, in an embodiment, system data structure table 820 may store canonical data model for various entities in an enterprise. In general, for an embodiment, changes to metadata of a system are to be registered in the system data structure table. In an embodiment, system data structure table 820 may contain source system ID, field names, field data types, field requirements, field lengths, system ID, and/or entity ID, although claimed subject matter is not limited in scope in these respects. Further, metadata mapping table 840 may store dependency information detected between canonical models of various applications, components, and/or systems in an enterprise. In an embodiment, metadata mapping table 840 may comprise ID fields for upstream and/or downstream systems, as well as a field to indicate active mapping activity. However, claimed subject matter is not limited in scope in these respects.

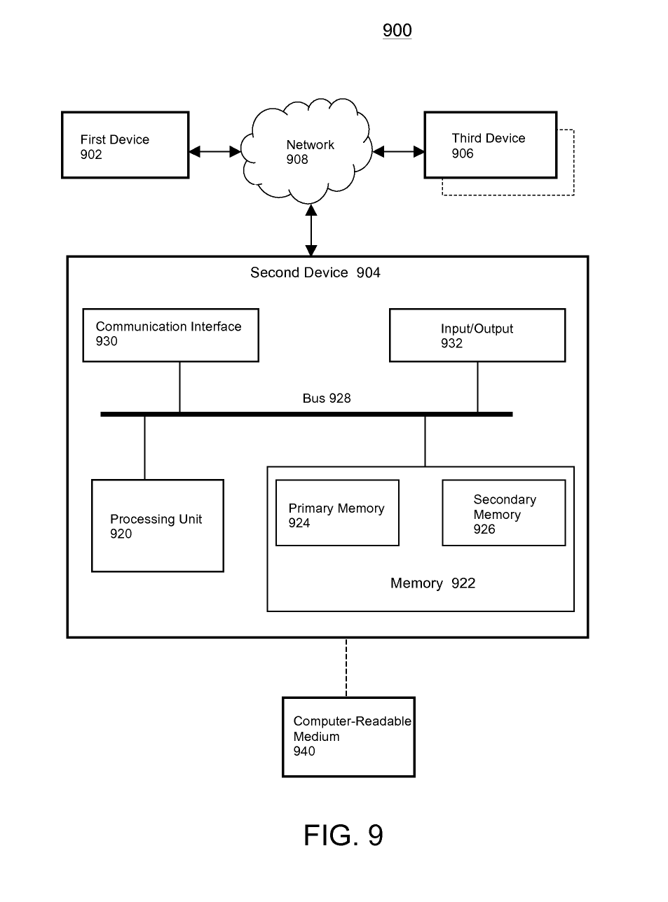

FIG. 9 is a block diagram illustrating an example system comprising a plurality of computing devices coupled via a network in accordance with an embodiment. For purposes of illustration, FIG. 9 is an illustration of an embodiment of a computing platform or computing device 904 that may be employed in a client-server type interaction, such as described infra. In FIG. 9, computing device 904, which may comprise features of a server computing device, may interface with a computing device 902, which may comprise features of a client device, for example. In other embodiments, computing device 904 may comprise a client computing device, and computing device 902 may comprise a server computing device, for example. In an embodiment, communications interface 930, processor (e.g., processing unit) 920, and memory 922, which may comprise primary memory 924 and secondary memory 926, may communicate by way of communication bus 928, for example. In FIG. 9, computing device 904 may store various forms of content, such as analog, uncompressed digital, lossless compressed digital, or lossy compressed digital formats for content of various types, such as video, imaging, text, audio, etc. in the form physical states or signals, for example. Computing device 904 may communicate with computing device 902 and/or with computing device 906 by way of an Internet connection via network 908, for example. Although the computing device 904 of FIG. 9 shows the above-identified components, claimed subject matter is not limited to computing platforms having only these components as other implementations may include alternative arrangements that may comprise additional components, fewer components, or components that function differently while achieving similar results. Rather, examples are provided merely as illustrations. It is not intended that claimed subject matter to limited in scope to illustrative examples.

Processor 920 may be representative of one or more circuits, such as digital circuits, to perform at least a portion of a computing procedure or process. By way of example but not limitation, processor 920 may comprise one or more processors, such as controllers, microprocessors, microcontrollers, application specific integrated circuits, digital signal processors, programmable logic devices, field programmable gate arrays, and the like, or any combination thereof. In implementations, processor 920 may perform signal processing to manipulate signals or states or to construct signals or states, for example.

Memory 922 may be representative of any storage mechanism. Memory 922 may comprise, for example, primary memory 924 and secondary memory 926, additional memory circuits, mechanisms, or combinations thereof may be used. Memory 922 may comprise, for example, random access memory, read only memory, or one or more data storage devices or systems, such as, for example, a disk drive, an optical disc drive, a tape drive, a solid-state memory drive, just to name a few examples. Memory 922 may be utilized to store a program, as an example. Memory 922 may also comprise a memory controller for accessing computer readable-medium 940 that may carry and/or make accessible content, code, and/or instructions, for example, executable by processor 920 or some other controller or processor capable of executing instructions, for example. Also, in an embodiment, memory 922 may store a local database cache, for example.

Under the direction of processor 920, memory, such as cells storing physical states, representing for example, a program, may be executed by processor 920 and generated signals may be transmitted via the Internet, for example. Processor 920 may also receive digitally-encoded signals from server 904.

Network 908 may comprise one or more communication links, processes, and/or resources to support exchanging communication signals between a client and server, which may, for example, comprise one or more servers (not shown). By way of example, but not limitation, network 908 may comprise wireless and/or wired communication links, telephone or telecommunications systems, Wi-Fi networks, Wi-MAX networks, the Internet, the web, a local area network (LAN), a wide area network (WAN), or any combination thereof.

The term “computing device,” as used herein, refers to a system and/or a device, such as a computer, that includes a capability to process and/or store data in the form of signals and/or states. Thus, a computing device, in this context, may comprise hardware, software, firmware, or any combination thereof (other than software per se). Computing device 904, as depicted in FIG. 9, is merely one such example, and the scope of claimed subject matter is not limited to this particular example. For one or more embodiments, a computing device may comprise any of a wide range of digital electronic devices, including, but not limited to, personal desktop or notebook computers, high-definition televisions, digital versatile disc (DVD) players and/or recorders, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing device.

Memory 922 may store cookies relating to one or more users and may also comprise a computer-readable medium that may carry and/or make accessible content, code and/or instructions, for example, executable by processor 920 or some other controller or processor capable of executing instructions, for example. A user may make use of an input device, such as a computer mouse, stylus, track ball, keyboard, or any other device capable of receiving an input from a user.

Regarding aspects related to a communications or computing network, a wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, and/or the like, which may move freely, randomly or organize themselves arbitrarily, such that network topology may change, at times even rapidly. Wireless network may further employ a plurality of network access technologies, including Long Term Evolution (LTE), WLAN, Wireless Router (WR) mesh, or 2nd, 3rd, or 4th generation (2G, 3G, or 4G) cellular technology, or other technologies, or the like. Network access technologies may enable wide area coverage for devices, such as client devices with varying degrees of mobility, for example.

A network may enable radio frequency or wireless type communications via a network access technology, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or other, or the like. A wireless network may include virtually any type of now known, or to be developed, wireless communication mechanism by which signals may be communicated between devices, such as a client device or a computing device, between or within a network, or the like.

Communications between a computing device and a wireless network may be in accordance with known, or to be developed cellular telephone communication network protocols including, for example, global system for mobile communications (GSM), enhanced data rate for GSM evolution (EDGE), and worldwide interoperability for microwave access (WiMAX). A computing device may also have a subscriber identity module (SIM) card, which, for example, may comprise a detachable smart card that stores subscription information of a user, and may also store a contact list of the user. A user may own the computing device or may otherwise be its primary user, for example. A computing device may be assigned an address by a wireless or wired telephony network operator, or an Internet Service Provider (ISP). For example, an address may comprise a domestic or international telephone number, an Internet Protocol (IP) address, and/or one or more other identifiers. In other embodiments, a communication network may be embodied as a wired network, wireless network, or combination thereof.

A computing device may vary in terms of capabilities or features. Claimed subject matter is intended to cover a wide range of potential variations. For example, a network device may include a numeric keypad or other display of limited functionality, such as a monochrome liquid crystal display (LCD) for displaying text. In contrast, however, as another example, a web-enabled computing device may include a physical or a virtual keyboard, mass storage, one or more accelerometers, one or more gyroscopes, global positioning system (GPS) or other location-identifying type capability, and/or a display with a higher degree of functionality, such as a touch-sensitive color 2D or 3D display, for example.

A computing device may include or may execute a variety of now known, or to be developed operating systems, or derivatives and/or versions, including personal computer operating systems, such as a Windows, iOS or Linux, or a mobile operating system, such as iOS, Android, or Windows Mobile, or the like. A computing device may include or may execute a variety of possible applications, such as a client software application enabling communication with other devices, such as communicating one or more messages, such as via email, short message service (SMS), or multimedia message service (MMS), including via a network, such as a social network including, but not limited to, Facebook, LinkedIn, Twitter, Flickr, or Google+, to provide only a few examples. A computing device may also include or execute a software application to communicate content, such as, for example, textual content, multimedia content, or the like. A computing device may also include or execute a software application to perform a variety of possible tasks, such as browsing, searching, playing various forms of content, including locally stored or streamed video, or games such as, but not limited to, fantasy sports leagues. The foregoing is provided merely to illustrate that claimed subject matter is intended to include a wide range of possible features or capabilities.

A network including a computing device, for example, may also be extended to another device communicating as part of another network, such as via a virtual private network (VPN). To support a VPN, transmissions may be forwarded to the VPN device. For example, a software tunnel may be created. Tunneled traffic may, or may not be encrypted, and a tunneling protocol may be substantially complaint with or substantially compatible with any past, present or future versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, or another existing protocol, or another protocol that may be developed.

A network may be compatible with now known, or to be developed, past, present, or future versions of any, but not limited to the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, or X.25. A network may employ, for example, TCP/IP, UDP, DECnet, NetBEUI, IPX, Appletalk, other, or the like. Versions of the Internet Protocol (IP) may include IPv4, IPv6, other, and/or the like.

It will, of course, be understood that, although particular embodiments will be described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example (other than software per se). Likewise, although claimed subject matter is not limited in scope in this respect, one embodiment may comprise one or more articles, such as a storage medium or storage media. Storage media, such as, one or more CD-ROMs and/or disks, for example, may have stored thereon instructions, executable by a system, such as a computer system, computing platform, or other system, for example, that may result in an embodiment of a method in accordance with claimed subject matter being executed, such as a previously described embodiment, for example; although, of course, claimed subject matter is not limited to previously described embodiments. As one potential example, a computing platform may include one or more processing units or processors, one or more devices capable of inputting/outputting, such as a display, a keyboard and/or a mouse, and/or one or more memories, such as static random access memory, dynamic random access memory, flash memory, and/or a hard drive.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms and/or symbolic representations of operations on binary signals or states, such as stored within a memory of a specific apparatus or special purpose computing device or platform. In the context of this particular specification, the term specific apparatus or the like includes a general purpose computing device, such as general purpose computer, once it is programmed to perform particular functions pursuant to instructions from program software.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involves physical manipulation of physical quantities. Typically, although not necessarily, such quantities may take the form of electrical and/or magnetic signals and/or states capable of being stored, transferred, combined, compared, processed or otherwise manipulated as electronic signals and/or states representing information. It has proven convenient at times, principally for reasons of common usage, to refer to such signals and/or states as bits, data, values, elements, symbols, characters, terms, numbers, numerals, information, and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing device. In the context of this specification, therefore, a special purpose computer and/or a similar special purpose computing device is capable of processing, manipulating and/or transforming signals and/or states, typically represented as physical electronic and/or magnetic quantities within memories, registers, and/or other information storage devices, transmission devices, and/or display devices of the special purpose computer and/or similar special purpose computing device. In the context of this particular patent application, as mentioned, the term “specific apparatus” may include a general purpose computing device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to the teachings of claimed subject matter without departing from one or more central concept(s) described herein. Therefore, it is intended that claimed subject matter not be limited to the particular examples disclosed, but that such claimed subject matter may also include all aspects falling within appended claims and/or equivalents thereof.

1. A method, comprising:
validating a change to a first digital object of a first computing system of an enterprise at least in part by detecting one or more dependencies between one or more attributes of the first digital object and one or more attributes of one or more additional digital objects utilizing, at least in part, a processing unit of a computing platform.

2. The method of claim 1, wherein said validating the change to the first digital object comprises obtaining attribute data for a plurality of components of one or more computing systems of the enterprise and storing the obtained attribute data in a memory of the computing system.

3. The method of claim 2, wherein the attribute data for the plurality of components of the one or more computing systems of the enterprise comprise dependency attribute metadata for the plurality of components.

4. The method of claim 3, wherein said validating the change to the first digital object comprises validating the dependency attribute metadata against one or more specified dependency rules.

5. The method of claim 4, wherein said validating the change to the first digital object comprises generating a list of dependencies based at least in part on results of said validating the dependency attribute metadata against the one or more specified dependency rules.

6. The method of claim 5, further comprising generating one or more recommended fixes based at least in part on results of said validating the dependency attribute metadata against the one or more specified dependency rules.

7. The method of claim 6, further comprising performing the one or more recommended fixes at least in part in response to said generating the one or more recommended fixes.

8. The method of claim 7, further comprising:
generating a report comprising the one or more recommended fixes; and
transmitting the report to a user computing platform.

9. A dependency management computing system, comprising:
a processor to validate a change to a first digital object of a first computing system of an enterprise at least in part by detecting one or more dependencies between one or more attributes of the first digital object and one or more attributes of one or more additional digital objects.

10. The system of claim 9, the processor to validate the change to the first digital object at least in part by obtaining attribute data for a plurality of components of one or more computing systems of the enterprise and storing the obtained attribute data in a memory of the dependency management computing system, wherein the attribute data for the plurality of components of the one or more computing systems of the enterprise comprise dependency attribute metadata for the plurality of components.

11. The system of claim 10, the processor to validate the change to the first digital object at least in part by validating the dependency attribute metadata against one or more specified dependency rules.

12. The system of claim 11, the processor to validate the change to the first digital object at least in part by generating a list of dependencies based at least in part on results of said validating the dependency attribute metadata against the one or more specified dependency rules.

14. The system of claim 13, the processor further to generate one or more recommended fixes based at least in part on results of said validating the dependency attribute metadata against the one or more specified dependency rules.

15. The system of claim 14, the processors further to perform the one or more recommended fixes at least in part in response to said generating the one or more recommended fixes.

16. The system of claim 15, the processor further to generate a report comprising the one or more recommended fixes, the system further comprising a communication interface to transmit the report to a user computing platform.

17. An article, comprising: a storage medium having stored thereon instructions executable by a processor to:
validate a change to a first digital object of a first computing system of an enterprise at least in part by detecting one or more dependencies between one or more attributes of the first digital object and one or more attributes of one or more additional digital objects.

18. The article of claim 17, the storage medium having stored thereon further instructions executable by the processor to validate the change to the first digital object at least in part by obtaining attribute data for a plurality of components of one or more computing systems of the enterprise and storing the obtained attribute data in a memory of the dependency management computing system.

19. The article of claim 18, wherein the attribute data for the plurality of components of the one or more computing systems of the enterprise comprise dependency attribute metadata for the plurality of components.

20. The article of claim 19, the storage medium having stored thereon further instructions executable by the processor to validate the change to the first digital object at least in part by validating the dependency attribute metadata against one or more specified dependency rules.
